(19) United States
(12) Patent Application Publication
(10) Pub. No.: US 2026/0292032 A1
(43) Pub. Date: Sep. 24, 2026

(54) SERVICE CONTINUITY FOR APPLICATIONS IN WIRELESS COMMUNICATIONS

(71) Applicant: Lenovo (Singapore) Pte. Limited, Singapore (SG)

(72) Inventor: Roozbeh Atarius, La Jolla, CA (US)

(73) Assignee: Lenovo (Singapore) Pte. Limited, Singapore (SG)

(21) Appl. No.: 19/480,207

(22) PCT Filed: Feb. 10, 2025
(86) PCT No.: PCT/IB2025/051376

§ 371 Date: Oct. 30, 2025

Related U.S. Application Data
(60) Provisional application No. 63/554,885, filed on Feb. 16, 2024.

(51) Int. Cl. H04L 67/148; H04L 67/12

(52) U.S. Cl. CPC H04L 67/148; H04L 67/12

(57) ABSTRACT

Various aspects of the present disclosure relate to service continuity for applications in wireless communications. An apparatus such as a first network equipment (NE) (e.g., a Vertical Application Layer (VAL) server) transmits to a second NE (e.g., a Network Slice Capability Exposure (NSCE) server), a first request message for a service operation, the first request message including a first resource Uniform Resource Identifier (URI) for a first Hypertext Transfer Protocol (HTTP) POST method and one or more first data types pertaining to a network slice. The service operation, for instance, includes an indication of service continuity for an application. The first NE receives, from the second NE, a first response message including an updated network slice.

### RELATED APPLICATION

This application claims priority to U.S. Provisional Application Ser. No. 63/554,885 filed 16 Feb. 2024 entitled “SERVICE CONTINUITY FOR APPLICATIONS IN WIRELESS COMMUNICATIONS,” the disclosure of which is incorporated by reference herein in its entirety.

### TECHNICAL FIELD

The present disclosure relates to wireless communications, and more specifically to application use in wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” cannot be construed as a reference to a closed set of conditions. For example, an example step that is described as “based on condition A” may be based on both a condition A and a condition B without departing from the scope of the present disclosure. In other words, as used herein, the phrase “based on” can be construed in the same manner as the phrase “based at least in part on”. Further, as used herein, including in the claims, a “set” may include one or more elements.

Some implementations of the method and apparatuses described herein may further include a first NE for wireless communication to transmit, to a second NE, a first request message for a service operation, the first request message including a first resource Uniform Resource Identifier (URI) for a first Hypertext Transfer Protocol (HTTP) POST method and one or more first data types pertaining to a network slice, the service operation including an indication of service continuity for an application; and receive, from the second NE, a first response message including an updated network slice.

In some implementations of the method and apparatuses described herein, the one or more first data types further include an indication of one or more UE associated with the application; the one or more UE include one or more Vertical Application Layer (VAL) UE; the service operation pertains to service continuity for the one or more VAL UE; the first resource URI includes {apiRoot}/nsce-scr/v1/; the first NE includes a VAL server; the second NE includes a first Network Slice Capability Exposure (NSCE) server; the at least one processor is configured to cause the first NE to transmit the first request message to the second NE based at least in part on an indication of mobility of one or more UE associated with the application.

Some implementations of the method and apparatuses described herein may further include a method performed by a first NE, the method including transmitting, to a second NE, a first request message for a service operation, the first request message including a first resource URI for a first HTTP POST method and one or more first data types pertaining to a network slice, the service operation including an indication of service continuity for an application; and receiving, from the second NE, a first response message including an updated network slice.

In some implementations of the method and apparatuses described herein, the method further including where the one or more first data types further include an indication of one or more UE associated with the application; the one or more UE include one or more VAL UE; the service operation pertains to service continuity for the one or more VAL UE; the first resource URI includes {apiRoot}/nsce-scr/v1/; the first NE includes a VAL server; the second NE includes a first NSCE server; transmitting the first request message to the second NE based at least in part on an indication of mobility of one or more UE associated with the application.

Some implementations of the method and apparatuses described herein may further include a NE for wireless communication to receive, from a first NE, a first request message for a service operation, the first request message including a first resource URI for a first HTTP POST method and one or more first data types pertaining to a network slice, the service operation including an indication of service continuity for an application; transmit, to a third NE, a second request message for the service operation including a second resource URI for a second HTTP POST method and one or more second data types pertaining to a network slice; receive, from the third NE, a second response message including an updated network slice; and transmit, to the first NE, a third response message including the updated network slice.

In some implementations of the method and apparatuses for a NE described herein, the one or more first data types further include an indication of one or more UE associated with the application; the one or more UE include one or more VAL UE; the updated network slice pertains to service continuity for the one or more VAL UE; the first resource URI includes {apiRoot}/nsce-scr/v1/; the first NE includes a VAL server; the second NE includes a first NSCE server; the third NE includes a second NSCE server; the second resource URI includes {apiRoot}/nsce-scn/v1/.

Some implementations of the method and apparatuses described herein may further include a method performed by a NE, the method including receiving, from a first NE, a first request message for a service operation, the first request message including a first resource URI for a first HTTP POST method and one or more first data types pertaining to a network slice, the service operation including an indication of service continuity for an application; transmitting, to a third NE, a second request message for the service operation including a second resource URI for a second HTTP POST method and one or more second data types pertaining to a network slice; receiving, from the third NE, a second response message including an updated network slice; and transmitting, to the first NE, a third response message including the updated network slice.

In some implementations of the method and apparatuses described herein, the method further including where the one or more first data types further include an indication of one or more UE associated with the application; the one or more UE include one or more VAL UE; the updated network slice pertains to service continuity for the one or more VAL UE; the first resource URI includes {apiRoot}/nsce-scr/v1/; the first NE includes a VAL server; the second NE includes a first NSCE server; the third NE includes a second NSCE server; the second resource URI includes {apiRoot}/nsce-scn/v1/.

Some implementations of the method and apparatuses described herein may further include a NE for wireless communication to receive, from a second NE, a second request message for a service operation including a second resource URI for a second HTTP POST method and one or more second data types pertaining to a network slice, the service operation including an indication of service continuity for an application; and transmit, to the second NE, a second response message including an updated network slice.

In some implementations of the method and apparatuses described herein, the one or more second data types further include an indication of one or more UE associated with the application; the one or more UE include one or more VAL UE; the updated network slice pertains to service continuity for the one or more VAL UE; the second resource URI includes {apiRoot}/nsce-scn/v1/; the second NE includes a first NSCE server and the third NE includes a second NSCE server.

Some implementations of the method and apparatuses described herein may further include a method performed by a NE, the method including receiving, from a second NE, a second request message for a service operation including a second resource URI for a second HTTP POST method and one or more second data types pertaining to a network slice, the service operation including an indication of service continuity for an application; and transmitting, to the second NE, a second response message including an updated network slice.

In some implementations of the method and apparatuses described herein, the method further including where the one or more second data types further include an indication of one or more UE associated with the application; the one or more UE include one or more VAL UE; the updated network slice pertains to service continuity for the one or more VAL UE; the second resource URI includes {apiRoot}/nsce-scn/v1/; the second NE includes a first NSCE server and the third NE includes a second NSCE server.

### BRIEF DESCRIPTION OF THE DRAWINGS

FIG. 1 illustrates an example of a wireless communications system in accordance with aspects of the present disclosure.

FIG. 2 illustrates a procedure for support for predictive slice modification in distributed NSCE server deployments.

FIG. 3 illustrates an example resource URI structure in accordance with aspects of the present disclosure.

FIG. 4 illustrates an example resource URI structure in accordance with aspects of the present disclosure.

FIG. 5 illustrates an example of a NE in accordance with aspects of the present disclosure.

FIG. 6 illustrates a flowchart of a method in accordance with aspects of the present disclosure.

FIG. 7 illustrates a flowchart of a method in accordance with aspects of the present disclosure.

FIG. 8 illustrates a flowchart of a method in accordance with aspects of the present disclosure.

### DETAILED DESCRIPTION

Wireless communications systems such as 5G networks can utilize network slicing to enable network operators to divide a single physical network into multiple distinct virtual connections, each tailored to specific types of traffic. Virtual slices can provide different types and amounts of resources that enable diverse functionality. Further, applications (e.g., productivity applications, gaming applications, communication applications, etc.) can be implemented in the context of network slices. Enabling application continuity across network slices, however, presents a number of implementation challenges.

Accordingly, aspects of the disclosure are directed to a framework for enabling service continuity for applications, such as across different network slices. The described solutions, for instance, can reduce service lag and data latency for applications in mobility scenarios, such as when a UE moves between different wireless service areas.

Aspects of the present disclosure are described in the context of a wireless communications system.

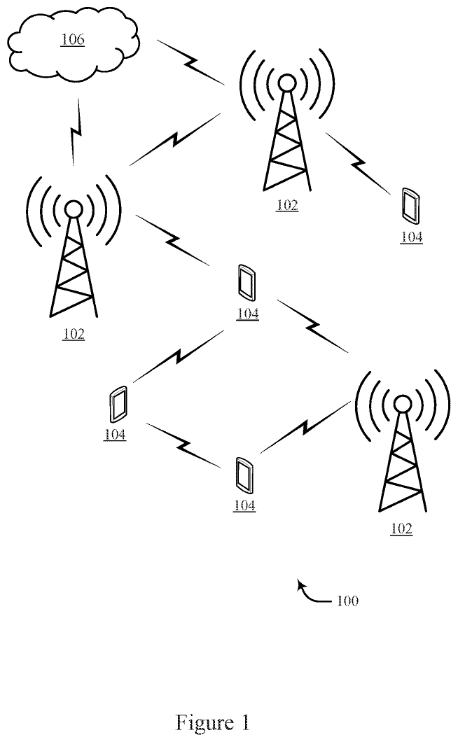

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, different NE 102 and the CN 106 can implement various entities such as VAL servers, NSCE servers, API providers, etc. For instance, VAL servers and NSCE servers can interact as part of network slicing in the context of the wireless communications system 100 to enable functionality such as slice API configuration, slice API configuration updating, slice API invocation, etc., to configure and expose functionality and services of network slice APIs.

With reference to application continuity for network slice applications, clause 9.9 of 3GPP Technical Specification (TS) 23.435 specifies stage 2 for predictive slice modification in edge based NSCE deployments which is the NSCE server initially receives an expected/predicted UE location/mobility change request outside an EDN service area for one or more UEs within the VAL application session (e.g. such session can be an indirect V2V session or a multiplayer gaming session). (See 3GPP TS 23.435 Release 18, Version 18.1.0, Jan. 5, 2024, titled “Procedures for Network Slice Capability Exposure for Application Layer Enablement Service,” hereinafter referred to as “3GPP TS 24.435”, which is hereby incorporated by reference herein in its entirety)

Then, the source NSCE server checks with 5GS (OAM, 5GC) whether the serving slice is available and can offer the same performance at the target EDN. Thereafter, NSCE server evaluates whether a slice modification is to be performed (e.g. a slice lifecycle related trigger change), such as a slice subnet resource adaptation to allow for optimizing the application performance at the target area. Based on this decision/recommendation, it provides the action to the OAM and supports the re-mapping of NSCE server for the NSCE client proactively, before UE mobility happens.

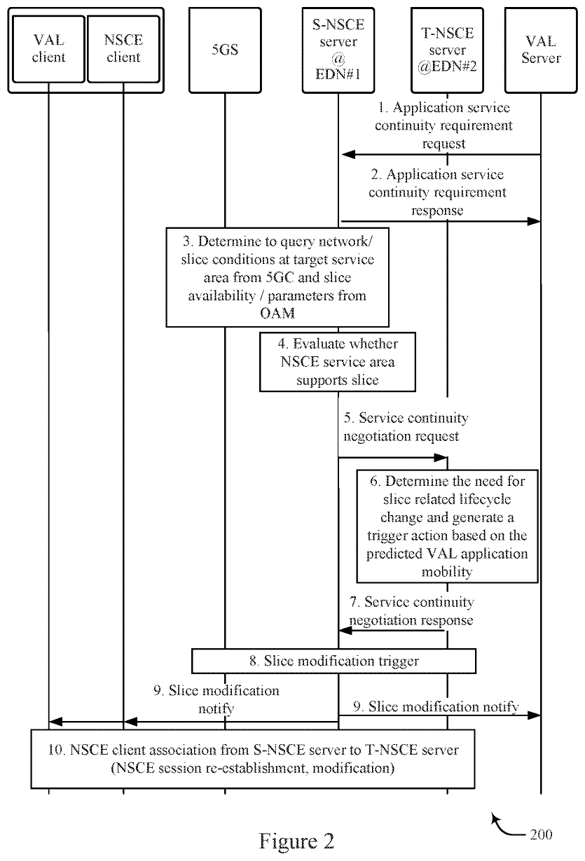

FIG. 2 illustrates a procedure 200 for support for predictive slice modification in distributed NSCE server deployments. In the procedure 200, a mechanism is provided to allow for slice modification when a vertical application of single or group of VAL UEs migrates and/or is expected/predicted to migrate to a different EDN supported by different NSCE server. Some pre-conditions to the procedure 200 include: (1) The VAL server has subscribed to the network slice capability enablement server; (2) The VAL client of VAL UE is mapped to Slice #1, and NSCE client of VAL UE has established a connection to NSCE server #1 (S-NSCE server); (3) The S-NSCE server has already discovered the T-NSCE server and its area of coverage; and (4) The VAL server is subscribed to and received prediction of UE location change.

In the procedure 200, at (1) The VAL server sends to S-NSCE server an application service continuity requirement request due to predicted/expected UE or group UE mobility to a target service area covered by a different EDN (Note: Such UE predicted mobility at the VAL server can be based on UE mobility analytics received by NWDAF or can be predicted by the VAL layer (VAL server or VAL UE)); (2) S-NSCE server sends an application service continuity requirement response to the VAL server as positive or negative acknowledgement; (3) S-NSCE server determines to query the underlying 3GPP system on the slice availability and conditions at the target service area (based on step 1 requirement). Such query may be in form of a request/response and include (a) S-NSCE server interacting with 5GC to query the UE specific information (location, UE connection capabilities) as well as network conditions (network monitoring from NEF) and/or slice related analytics on the slice load (from NWDAF as specified in TS 23.288) (see 3GPP TS 23.288, Release 18, Version 18.4.0, Dec. 19, 2023, titled “Architecture enhancements for 5G System (5GS) to support network data analytics services,” hereinafter referred to as “3GPP TS 23.288”, which is hereby incorporated by reference herein in its entirety); (b) S-NSCE server may also interact with OAM to query on the target slice availability and the up-to-date configured slice parameters e.g. slice RRM policies, modification of the NSI/NSSI resources (see TS 28.531 5.1.12) at the target service area and measurements for the slice at the target area. (see 3GPP TS 28.531, Release 18, Version 18.4.0, Jan. 5, 2024, titled “Management and orchestration; Provisioning,” hereinafter referred to as “3GPP TS 28.531”, which is hereby incorporated by reference herein in its entirety)

Further to the procedure 200: at (4) S-NSCE server evaluates whether new NSCE service area supports slice #1 and if slice #1 offers similar performance in target area; (5) If the current slice doesn't fulfil these requirements, S-NSCE sends to the T-NSCE server (covering the target area) a service continuity negotiation request (including the VAL application service continuity requirement and optionally a proposed action) to negotiate on the trigger action; (6) T-NSCE server determines whether a slice lifecycle change is to be performed at the target area and translates this to a trigger action. This trigger action can be based on the proposed action in step 5 and can be a requested slice modification or the slice #1 creation/instantiation at the target area (this may happen if a group of UEs are moving to the target area and use slice #1, so it may be beneficial to create slice #1 at the target area); (7) T-NSCE server sends to the S-NSCE server a service continuity negotiation response including the determined trigger action: (8) The S- or T-NSCE server may send the trigger action as a slice modification trigger request to the slice provisioning MnS producer at OAM (e.g. slice modification for network slice) to extend slice availability to the target service area based on the expected/predicted VAL UE or VAL group mobility. As response to the trigger action, the provisioning MnS producer provides a slice modification trigger response to the corresponding NSCE server with a positive or negative result (9) After the slice lifecycle change execution (based on the indication in step 5), the S-NSCE server sends a notification to the VAL server and optionally to the VAL client via S-NSCE client; and (10) If the NSCE client is to be remapped to different NSCE server (due to the expected change of UE location), the NSCE client establishes a new connection with T-NSCE and terminates the one with S-NSCE (in case of subscription-based interaction), or in case of request-based interaction, it updates the mapping at the client side, and maintains the new NSCE server address/ID for the target NSCE area.

Accordingly, aspects of the present disclosure include solutions for APIs for an application service continuity parameter services for communication between a VAL Server and a NSCE Server, and API for application service continuity negotiation service for communication between the Source NSCE server and Target NSCE server.

For an API for application service continuity requirement (e.g., NSCE_ServiceContinuityRequirement), the service exposed by the NSCE Server enables a service consumer to send an application service continuity requirement due to expected or predicted of one or more VAL UEs' mobility to a target service area, and the service consumer to receive the slice which is expected or predicted to extend the application service continuity at the target service area.

Service operations defined for the application service continuity service are illustrated in Table 1:

TABLE 1
NSCE_ServiceContinuityRequirement Service Operations

| Service Operation | | Initiated |
|---|---|---|
| Name | Description | by |
| Val_Application_{—} | This service operation is used to | VAL |
| Continuity_{—} | send the VAL application service | Server |
| Requirement | continuity requirement. | |
| Val_Application_{—} | This service operation is used to | NSCE |
| Continuity_Slice | provide information about the | Server |
| | extended slice availability. | |

For the Val_Application_Continuity_Requirement, this service operation is used by the VAL Server to provide the NSCE Server the VAL application service continuity requirement and can be used for requesting service continuity for VAL application. For instance, to request for the VAL application service continuity, the VAL Server can send an HTTP POST request with a Request-URI according to the pattern “{apiRoot}/nsce-scr/<apiVersion>/srvContdRegt” and with a body including data type SrvContdRegt. Upon receipt of the HTTP POST request, the NSCE Server can: (1) verify the identity of the VAL Server and determine if the VAL Server is authorized to request for the service continuity of the VAL application; and (2) if the VAL Server: (a) is not authorized, the NSCE Server can respond to the VAL Server with an appropriate error status code; or (b) is authorized, the NSCE Server can respond to the VAL server: (i) if the request is successfully processed, a “204 No Content” status code and process the event notification; or (ii) if errors occur when processing the request, an appropriate error response as specified herein.

For the Val_Application_Continuity_Slice service operation, this service operation can be used by the NSCE Server to provide the VAL Server the extended slice availability for the VAL application service continuity. For instance, for providing extended slice availability for service continuity of VAL application by using Val_Application_Continuity_Slice, the NSCE Server can send an HTTP POST request with a Request-URI according to the pattern “{apiRoot}/nsce-scr/<apiVersion>/slModifNtfy” and with a body including data type SlodifNtfy such as defined in herein. Upon receipt of the HTTP POST request, the VAL Server can: (1) verify the identity of the NSCE Server and determine if the NSCE Server is authorized to provide extended slice availability for service continuity of the VAL application; and (2) if the NSCE Server: (a) is not authorized, the VAL Server can respond to the NSCE Server with an appropriate error status code; or (b) is authorized, the VAL Server can respond to the NSCE Server: (i) if the request is successfully processed, a “204 No Content” status code and process the event notification; or (ii) if errors occur when processing the request, an appropriate error response such as specified herein.

In implementations the NSCE_ServiceContinuityRequirement service can use the NSCE_ServiceContinuityRequirement API. The request URIs used in HTTP requests from the VAL Server towards the NSCE Server can have the Resource URI structure as defined in clause 5.2.4 of 3GPP TS 29.122 [2] with the following clarifications (see 3GPP TS 29.122, Release 18, Version 18.4.0, Dec. 18, 2023, titled “T8 reference point for Northbound APIs,” hereinafter referred to as “3GPP TS 29.122”, which is hereby incorporated by reference herein in its entirety):
The <apiName> can be “nsce-scr”.
The <apiVersion> can be “v1”.
The <apiSpecificSuffixes> can be set such as described herein.

Regarding usage of HTTP and common API-related aspects, the provisions of clause 5.2 of 3GPP TS 29.122 can apply for the NSCE_ServiceContinuityRequirement API.

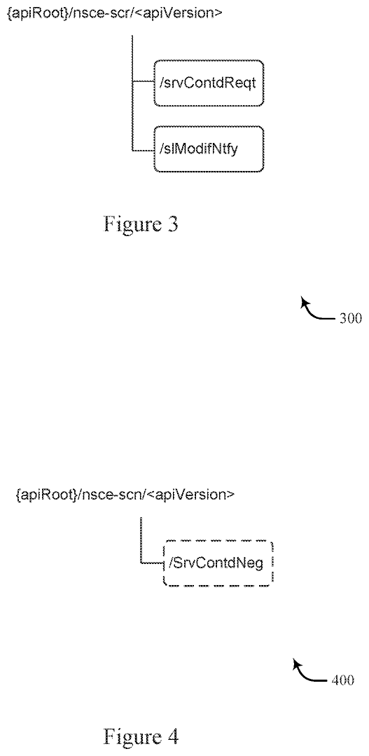

FIG. 3 illustrates an example resource URI structure 300 in accordance with aspects of the present disclosure. The resource URI structure 300, for instance, represents a structure for URIs for the NSCE_ServiceContinuityRequirement API.

Table 2 provides an overview of the resources and applicable HTTP methods for the NSCE_ServiceContinuityRequirement API.

TABLE 2
Resources and methods overview

| | | HTTP | |
|---|---|---|---|
| | | method | |
| | | or | |
| Resource | Resource | custom | |
| name | URI | operation | Description |
| Service | /srvContdReqt | POST | Requests for service |
| continuity | | | continuity for a VAL |
| requirement | | | application |
| Slice | /slModifNtfy | POST | Notifies slice modification for |
| modification | | | service continuity of a VAL |
| notification | | | application |

For the service continuity requirement resource, this resource can be used to request service continuity of a VAL application due to predicted or expected one or more UEs mobility to a target service area which is in a different Edge Data Network (EDN).

Regarding a resource definition, a resource URI can be:

$$\{ apiRoot \} / < nsce - scr > / < apiVersion > / srvContdReqt$$

The service continuity requirement resource can support the resource URI variables defined in Table 3 below.

TABLE 3
Resource URI variables

| Name | Data type | Definition |
|---|---|---|
| apiRoot | string | Such as described herein |

For the service continuity requirement resource, the POST method can support the URI query parameters specified in Table 4.

TABLE 4
URI query parameters supported by the POST method

| | | | | | |
|---|---|---|---|---|---|
| Name | Data type | P | Cardinality | Description | Applicability |

n/a

The POST method for the service continuity requirement resource can support the request data structures specified in Table 5 and the response data structures and response codes specified in Table 6, below.

TABLE 5
Data structures supported by the POST Request Body

| Data type | P | Cardinality | Description |
|---|---|---|---|
| SrvContdReqt | M | 1 | Presents the service continuity |
| | | | requirement for a VAL application |
| | | | due to one or more VAL UE mobility |
| | | | to a target area. |

TABLE 6
Data structures supported by the POST Response Body

| Data | | | Response | |
|---|---|---|---|---|
| type | P | Cardinality | codes | Description |
| n/a | | | 204 No | Successful case. The service |
| | | | Content | continuity requitement for the VAL |
| | | | | application has been successfully |
| | | | | received, and no content is |
| | | | | returned in the response body. |

NOTE:
The manadatory HTTP error status code for the HTTP POST method listed in table 5.2.6-1 of 3GPP TS 29.122 can also apply.

For the slice modification notification resource, this resource can be used to notify slice modification for the service continuity of a VAL application due to predicted or expected one or more UE mobility to a target service area which is in a different Edge Data Network (EDN). An example resource URI: {apiRoot}/<nsce-scr>/<apiVersion>/slModifNtfy and this resource can support the resource URI variables defined in Table 7.

TABLE 7
Resource URI variables for this resource

| Name | Data type | Definition |
|---|---|---|
| apiRoot | string | Such as defined herein |

The slice modification notification resource can utilize the POST method which can support the URI query parameters specified in Table 8.

TABLE 8
URI query parameters supported by the POST method

| | | | | | |
|---|---|---|---|---|---|
| Name | Data type | P | Cardinality | Description | Applicability |

n/a

Further, the POST method can support the request data structures specified in Table 9 and the response data structures and response codes specified in Table 10.

TABLE 9
Data structures supported by the POST Request Body

| Data type | P | Cardinality | Description |
|---|---|---|---|
| SlModifNtfy | M | 1 | Presents the slice modification |
| | | | notification for service continuity of a |
| | | | VAL application due to one or more |
| | | | VAL UE mobility to a target area. |

TABLE 10
Data structures supported by the POST Response Body

| Data | | | Response | |
|---|---|---|---|---|
| type | P | Cardinality | codes | Description |
| n/a | | | 204 No | Successful case. The slice |
| | | | Content | modification notification for the |
| | | | | service continuity of the VAL |
| | | | | application has been successfully |
| | | | | received, and no content is |
| | | | | returned in the response body. |

NOTE:
The manadatory HTTP error status code for the HTTP POST method listed in table 5.2.6-1 of 3GPP TS 29.122 may also apply.

Regarding the data model supported by API for application service continuity requirement API (e.g., NSCE_ServiceContinuityRequirement API), Table 11 specifies the data types defined for the NSCE_ServiceContinuityRequirment API.

TABLE 11
NSCE_ServiceContinuityRequirment API specific Data Types

| | | | |
|---|---|---|---|
| Data type | Clause defined | Description | Applicability |

Table 12 specifies data types re-used by the NSCE_ServiceContinuityRequirment API from other specifications, including a reference to their respective specifications, and a short description of their use within the NSCE_ServiceContinuityRequirment API.

TABLE 12
NSCE_ServiceContinuityRequirment API re-used Data Types

| | | | |
|---|---|---|---|
| Data type | Reference | Comments | Applicability |

| | | |
|---|---|---|
| AccToken | 6.Y.6.2.4 | Indicates access token standard claims, |
| | | specified in 3GPP TS 33.122. (see 3GPP |
| | | TS 33.122, Release 18, Version 18.2.0, |
| | | Jan. 4, 2024, titled “Security aspects of |
| | | Common API Framework (CAPIF) for |
| | | 3GPP northbound APIs,” hereinafter |
| | | referred to as “3GPP TS 33.122”, which is |
| | | hereby incorporated by reference herein in |
| | | its entirety) |
| LocationArea5G | 3GPP TS 29.122 | Represents the location information. |
| NetSliceId | 6.3.6.2.15 | Identifies the S-NSSAI. |
| ValTargetUe | 3GPP TS 29.549 | Used to identify either a VAL User ID or a |
| | (3GPP TS | VAL UE ID. |
| | 29.549, Release | |
| | 18, Version | |
| | 18.4.0, | |
| | Dec. 18, | |
| | 2023, titled | |
| | “Service Enabler | |
| | Architecture | |
| | Layer for | |
| | Verticals | |
| | (SEAL); | |
| | Application | |
| | Programming | |
| | Interface (API) | |
| | specification; | |
| | Stage 3,” | |
| | hereinafter | |
| | referred to as | |
| | “3GPP TS | |
| | 29.549”, which is | |
| | hereby | |
| | incorporated by | |
| | reference herein | |
| | in its entirety) | |

The following discusses data structure types that can be used in resource representations for the NSCE_ServiceContinuityRequirment API. For instance, Table 13 illustrates example structures for the SrvContdReqt data type and Table 14 illustrates example structures for the SlModifNtfy data type.

TABLE 13
Definition of type SrvContdReqt

| | | | | | |
|---|---|---|---|---|---|
| Attribute | | | | | |
| name | Data type | P | Cardinality | Description | Applicability |

| | | | | |
|---|---|---|---|---|
| valSrvId | string | M | 1 | The identifier of the VAL service |
| | | | | for which the requirement |
| | | | | request applies |
| contdReqt | string | M | 1 | The service continuity |
| | | | | requirement which can be the |
| | | | | expected or predicted migration |
| | | | | of the VAL application or a list |
| | | | | of VAL UEs within the |
| | | | | application to a target area. |
| authInfo | AccToken | M | 1 | Authorization information to |
| | | | | request for the slice API |
| | | | | invocation. |
| valUeIdsList | array(ValTargetUe) | O | 0 . . . N | The list of VAL UE IDs for |
| | | | | which the requirement request |
| | | | | applies |
| netSliceId | NetSliceId | O | 0 . . . 1 | Identifier of the network slice for |
| | | | | which is mapped to the VAL |
| | | | | application. |
| trgtSrvArea | LocationArea5G | O | 0 . . . 1 | Geographical coordinates of the |
| | | | | target area, where the VAL |
| | | | | application and the one or more |
| | | | | VAL UEs are expected or |
| | | | | predicted to move to. |
| appQosReqt | string | O | 0 . . . 1 | The QoS requirements for the |
| | | | | VAL service |

TABLE 14
Definition of type SlModifNtfy

| | | | | | |
|---|---|---|---|---|---|
| Attribute | | | | | |
| name | Data type | P | Cardinality | Description | Applicability |

| | | | | |
|---|---|---|---|---|
| netSliceId | NetSliceId | M | 1 | Identifier of the network slice for |
| | | | | which is expected or predicted to |
| | | | | modify to extend slice |
| | | | | availability to the target service |
| | | | | area. |
| trgtSrvArea | LocationArea5G | M | 1 | Geographical coordinates of the |
| | | | | target area, where the VAL |
| | | | | application and the one or more |
| | | | | VAL UEs are expected or |
| | | | | predicted to move to. |
| tNSCE | array(string) | M | 1 . . . 2 | The identifier and the address of |
| | | | | the target NSCE server |
| valUeIdsList | array(ValTargetUe) | O | 0 . . . N | The list of VAL UE IDs for |
| | | | | which the requirement request |
| | | | | applies |

Regarding error handling for the NSCE_ServiceContinuityRequirment API, HTTP error responses can be supported as specified in clause 5.2.6 of 3GPP TS 29.122. Protocol errors and application errors specified in clause 5.2.6 of 3GPP TS 29.122 can be supported for the HTTP status codes specified in table 5.2.6-1 of 3GPP TS 29.122. In addition, the requirements in the following clauses are applicable for the NSCE_ServiceContinuityRequirment API.

Table 15 illustrates example application errors defined for the NSCE_ServiceContinuityRequirment API.

TABLE 15
Application errors

| | | | |
|---|---|---|---|
| Application | HTTP | Description | Applicability |
| Error | status code | | |

Regarding feature negotiation, features in Table 16 are defined for the NSCE_ServiceContinuityRequirment API. They can be negotiated using the extensibility mechanism defined in clause 5.2.7 of 3GPP TS 29.122.

TABLE 16
Supported Features

| | | |
|---|---|---|
| Feature number | Feature Name | Description |

Regarding security, the provisions of clause 6 of 3GPP TS 29.122 can apply for the NSCE_ServiceContinuityRequirment API.

The following presents example YAML code for an example NSCE_ServiceCotinuityRequirement API.

```
openapi: 3.0.0
info:
  title: NSCE_ServiceContinuityRequirement
  version: 1.0.0-alpha.1
  description: |
  NSCE Server VAL Application Service Continuation Requirement Service.
  © <2024>, 3GPP Organizational Partners (ARIB, ATIS, CCSA, ETSI, TSDSI,
TTA, TTC).
  All rights reserved.
externalDocs:
  description: >
  3GPP TS 29.435 V0.2.0; Service Enabler Architecture Layer for Verticals
  (SEAL);
  Network Slice Capability Exposure (NSCE) Server Services; Stage 3.
  url: http://www.3gpp.org/ftp/Specs/archive/29_series/29.435/
servers:
  - url: ‘{apiRoot}/nsce scr/v1’
  variables:
  apiRoot:
  default: https://example.com
  description: apiRoot as defined in clause 6.5 of 3GPP TS 29.549
security:
  - { }
  - oAuth2ClientCredentials: [ ]
paths:
  /srvContdReqt:
  post:
  summary: Service continuity request for a VAL application.
  operationId: ServiceContinuityRequirement
  tags:
  - Service Continuity Requirement
  request Body:
  required: true
  content:
  application/json:
  schema:
  $ref: ‘#/components/schemas/SrvCortdReqt’
  responses:
  ‘204’:
  description: >
  The service continuity requirement for the VAL application has been
successfully
  received, and no content is returned in the response body.
  ‘307’:
  $ref: ‘TS29122_CommonData.yaml#/components/responses/307’
  ‘308’:
  $ref: ‘TS29122_CommonData.yaml#/components/responses/308’
  ‘400’:
  $ref: ‘TS29122_CommonData.yaml#/components/responses/400’
  ‘401’:
  $ref: ‘TS29122_CommonData.yaml#/components/responses/401’
  ‘403’:
  $ref: ‘TS29122_CommonData.yaml#/components/responses/403’
  ‘404’:
  $ref: ‘TS29122_CommonData.yaml#/components/responses/404’
  ‘411’:
  $ref: ‘TS29122_CommonData.yaml#/components/responses/411’
  ‘413’:
  $ref: ‘TS29122_CommonData.yaml#/components/responses/413’
  ‘415’:
  $ref: ‘TS29122_CommonData.yaml#/components/responses/415’
  ‘429’:
  $ref: ‘TS29122_CommonData.yaml#/components/responses/429’
  ‘500’:
  $ref: ‘TS29122_CommonData.yaml#/components/responses/500’
  ‘503’:
  $ref: ‘TS29122_CommonData.yaml#/components/responses/503’
  default:
  $ref: ‘TS29122_CommonData.yaml#/components/responses/default’
  /slModifNtfy:
  post:
  summary: Notifies slice modification for service continuity of a VAL
application.
  operationId: NotifyModifiedRequirement
  tags:
  - Notify Modification Requirement
  requestBody:
  required: true
  content:
  application/json:
  schema:
  $ref: ‘#/components/schemas/SlModifNtfy’
  responses:
  ‘204’:
  description: >
  The slice modification notification for the service continuity of the
VAL application
  has been successfully received, and no content is returned in the
response body.
  ‘307’:
  $ref: ‘TS29122_CommonData.yaml#/components/responses/307’
  ‘308’:
  $ref: ‘TS29122_CommonData.yaml#/components/responses/308’
  ‘400’:
  $ref: ‘TS29122_CommonData.yaml#/components/responses/400’
  ‘401’:
  $ref: ‘TS29122_CommonData.yaml#/components/responses/401’
  ‘403’:
  $ref: ‘TS29122_CommonData.yaml#/components/responses/403’
  ‘404’:
  $ref: ‘TS29122_CommonData.yaml#/components/responses/404’
  ‘411’:
  $ref: ‘TS29122_CommonData.yaml#/components/responses/411’
  ‘413’:
  $ref: ‘TS29122_CommonData.yaml#/components/responses/413’
  ‘415’:
  $ref: ‘TS29122_CommonData.yaml#/components/responses/415’
  ‘429’:
  $ref: ‘TS29122_CommonData.yaml#/components/responses/429’
  ‘500’:
  $ref: ‘TS29122_CommonData.yaml#/components/responses/500’
  ‘503’:
  $ref: ‘TS29122_CommonData.yaml#/components/responses/503’
  default:
  $ref: ‘TS29122_CommonData.yaml#/components/responses/default’
components:
  securitySchemes:
  oAuth2ClientCredentials:
  type: oauth2
  flows:
  clientCredentials:
  tokenUrl: ‘{tokenUrl}’
  scopes: { }
  schemas:
#
# STRUCTURED DATA TYPES
#
  SrvContdReqt:
  description: >
  Represents the service continuity requirement for a VAL application.
  type: object
  properties:
  valSrvId:
  type: string
  contdReqt:
  type: string
  authInfo:
  $ref:
‘TS29435_NSCE_SliceApiInvocation.yaml#/components/schemas/AccToken’
  valUeIdsList:
  type: array
  items:
  $ref:
‘TS29549_SS_UserProfileRetrieval.yaml#/components/schemas/ValTargetUe’
  minItems: 1
  netSliceId:
  $ref:
‘TS29435_NSCE_PolicyManagement.yaml#/components/schemas/NetSliceId’
  trgtSrvArea:
  $ref: ‘TS29122_CommonData.yaml#/components/schemas/LocationArea5G’
  appQosReqt:
  type: string
  required:
  - valSrvId
  - contdReqt
  - authInfo
  SlModifNtfy:
  Description: >
  Represents the slice modification notification for service continuity of
a VAL application.
  type: object
  properties:
  netSliceId:
  $ref:
‘TS29435_NSCE_PolicyManagement.yaml#/components/schemas/NetSliceId’
  trgtSrvArea:
  $ref: ‘TS29122_CommonData.yaml#/components/schemas/LocationArea5G’
  tNSCE:
  type: array
  items:
  type: string
  minitems: 1
  valUeIdsList:
  type: array
  items:
  $ref:
‘TS29549_SS_UserProfileRetrieval.yaml#/components/schemas/ValTargetUe’
  minItems: 1
  required:
  - netSliceId
  - trgtSrvArea
  - tNSCE
```

Implementations described herein also provide APIs for service continuity negotiation, e.g., via a ServiceContinuityNegotiation service exposed by the Source NSCE Server that enables a Target NSCE server to determine trigger action to create or modify a slice to be used at the target service area for the application service continuity.

Example service operations for the NSCE_ServiceContinuityNegotitation service are shown in Table 17.

TABLE 17
NSCE_ServiceContinuityNegotiation Service Operations

| Service | | |
|---|---|---|
| Operation Name | Description | Initiated by |
| Val_Application_{—} | This service operation is | Source NSCE |
| Continuity_{—} | used to negotiate the service | Server |
| Negotiation | continuity. | |

For the Val_Application_Continuity_Negotiation, this service operation can be used by the Source NSCE Server to negotiate with the Target NSCE Server the VAL the service continuity for the VAL application. To request for negotiation of the VAL application service continuity, the Source NSCE Server can send an HTTP POST request with a Request-URI according to the pattern “{apiRoot}/nsce-scr/<apiVersion>/SrvContdNeg” and with a body including data type SrvContdNegReq as such as defined herein.

Upon receipt of the HTTP POST request, the Target NSCE Server can: (1) verify the identity of the Source NSCE Server and determine if the Source NSCE Server is authorized to request for negotiation of the service continuity of the VAL application; and (2) if the Source NSCE Server: (a) is not authorized, the Target NSCE Server can respond to the Source NSCE Server with an appropriate error status code; or (b) is authorized, the Target NSCE Server can respond to the Source NSCE Server: (i) if the request is successfully processed, with an HTTP “200 OK” status code, with the response body including the SrvContdNegRes data structure such as defined herein, including the result of the negotiated trigger action for one or more target UEs or the VAL application; or (ii) if errors occur when processing the request, an appropriate error response such as specified herein.

The NSCE_ServiceContinuityNegotiation service can use the NSCE_ServiceContinuityNegotiation API. The request URIs used in HTTP requests from the Source NSCE (S-NSCE) Server towards the Target NSCE (T-NSCE) Server can have a resource URI structure such as defined in clause 5.2.4 of of 3GPP TS 29.122 with the following clarifications:
The <apiName> can be “nsce-sen”.
The <apiVersion> can be “v1”.
The <apiSpecificSuffixes> can be set as described in clause 5.3.2.4.

Regarding usage of HTTP and common API-related aspects, the provisions of clause 5.2 of 3GPP TS 29.122 can apply for the NSCE_ServiceContinuityNegotiation API.

FIG. 4 illustrates an example resource URI structure 400 in accordance with aspects of the present disclosure. The resource URI structure 400, for instance, represents a structure for URIs for the URIs of the NSCE_ServiceContinuityNegotiation API.

Table 18 provides an overview of the custom operations and applicable HTTP methods defined for the NSCE_ServiceContinuityNegotiation API and Table 19 provides example custom operations that can support the URI variables.

TABLE 18
Custom operations without associated resources

| Custom | Custom | Mapped | |
|---|---|---|---|
| operation | operation | HTTP | |
| name | URI | method | Description |
| Service | /SrvContdNeg | POST | Enables to negotiate for |
| continuity | | | service continuity of a VAL |
| negotiation | | | application due to predicted or |
| | | | expected one or more UEs |
| | | | mobility to a target service |
| | | | area which is in a different |
| | | | EDN. |

TABLE 19
URI variables

| Name | Data type | Definition |
|---|---|---|
| apiRoot | string | See clause 5.3.2.1. |

Regarding the service continuity negotiation custom operation, this custom operation enables the S-NSCE Server negotiate to the T-NSCE for the service continuity of a VAL application due to predicted or expected one or more UEs mobility to a target service area which is in a different EDN. This operation can support the request data structures specified in Table 20 and the response data structures and response codes specified in Table 21.

TABLE 20
Data structures supported by the POST Request Body

| Data type | P | Cardinality | Description |
|---|---|---|---|
| SrvContdNegReq | M | 1 | Request for negotiation of a service |
| | | | continuity requirement for a VAL |
| | | | application due to one or more |
| | | | VAL UE mobility to a target area. |

TABLE 21
Data structures supported by the POST Response Body

| | | | Response | |
|---|---|---|---|---|
| Data type | P | Cardinality | codes | Description |
| SrvContdNegRes | | | 200 OK | The negotiation for the service continuity of the |
| | | | | VAL application request is successfully received |
| | | | | and processed. |
| n/a | | | 307 | Temporary redirection. |
| | | | Temporary | The response can include a Location header |
| | | | Redirect | field including an alternative target URI located |
| | | | | in an alternative T-NSCE Server. |
| | | | | Redirection handling is described in |
| | | | | clause 5.2.10 of 3GPP TS 29.122 [2]. |
| n/a | | | 308 | Permanent redirection. |
| | | | Permanent | The response can include a Location header |
| | | | Redirect | field including an alternative target URI located |
| | | | | in an alternative T-NSCE Server. |
| | | | | Redirection handling is described in |
| | | | | clause 5.2.10 of 3GPP TS 29.122 [2] |

NOTE:
The manadatory HTTP error status codes for the HTTP POST method listed in table 5.2.6-1 of 3GPP TS 29.122 can also apply.

TABLE 22
Headers supported by the 307 Response Code

| | Data | | | |
|---|---|---|---|---|
| Name | type | P | Cardinality | Description |
| Location | string | M | 1 | Includes an alternative target |
| | | | | URI located in an alternative |
| | | | | T-NSCE Server. |

TABLE 23
Headers supported by the 308 Response Code

| | Data | | | |
|---|---|---|---|---|
| Name | type | P | Cardinality | Description |
| Location | string | M | 1 | Includes an alternative target |
| | | | | URI located in an alternative |
| | | | | TNSCE Server. |

Regarding data models for APIs for service continuity negotiation, Table 24 specifies example data types defined for the NSCE_ServiceContinuityNegotiation API and Table 25 specifies data types re-used by the NSCE_ServiceContinuityNegotiation API from other specifications.

TABLE 24
NSCE_ServiceContinuityNegotiation API specific Data Types

| | | | |
|---|---|---|---|
| Data type | Clause | Description | Applicability |
| | defined | | |

TABLE 25
NSCE_ServiceContinuityNegotiation API re-used Data Types

| | | | |
|---|---|---|---|
| Data type | Reference | Comments | Applicability |

| | | |
|---|---|---|
| NetSliceId | 6.3.6.2.15 | Identifies the S-NSSAI. |
| ValTargetUe | 3GPP TS | Used to identify either a |
| | 29.549 | VAL User ID or a VAL UE ID. |

Regarding structured data types for the NSCE_ServiceContinuityNegotiation API, Table 26 includes example definitions for SrvContdNegReq and Table 27 includes example definitions for SrvContdNegRes.

TABLE 26
Definition of type SrvContdNegReq

| | | | | | |
|---|---|---|---|---|---|
| Attribute | | | | | |
| name | Data type | P | Cardinality | Description | Applicability |

| | | | | |
|---|---|---|---|---|
| valSrvId | string | M | 1 | The identifier of the VAL service |
| | | | | for which the requirement |
| | | | | request applies |
| netSliceId | NetSliceId | M | 1 | Identifier of the network slice for |
| | | | | which is mapped to the VAL |
| | | | | application. |
| contdReqt | string | M | 1 | The service continuity |
| | | | | requirement which can be the |
| | | | | expected or predicted migration |
| | | | | of the VAL application or a list |
| | | | | of VAL UEs within the |
| | | | | application to a target area. |
| valUeIdsList | array(ValTargetUe) | O | 0 . . . N | The list of VAL UE IDs for |
| | | | | which the requirement request |
| | | | | applies |
| appQosReqt | string | O | 0 . . . 1 | The QoS requirements for the |
| | | | | VAL service |
| propTrigAcn | TrigAcn | O | 0 . . . 1 | The proposed trigger action for |
| | | | | the target VAL UE or VAL |
| | | | | application, where the trigger |
| | | | | action is the lifecycle of the |
| | | | | slice. |

TABLE 27
Definition of type SrvContdNegRes

| | | | | | |
|---|---|---|---|---|---|
| Attribute | | | | | |
| name | Data type | P | Cardinality | Description | Applicability |

| | | | | |
|---|---|---|---|---|
| srvContNegRslt | boolean | M | 1 | Indicates on the result of the |
| | | | | request for service continuity of |
| | | | | the VAL application: |
| | | | | if set to “1”, is possible; or |
| | | | | if set to “0”, is not possible. |
| trigAcn | TrigAcn | O | 0 . . . 1 | Negotiated trigger action for the |
| | | | | target VAL UE or VAL |
| | | | | application, where the trigger |
| | | | | action is the lifecycle of the |
| | | | | slice. |

Regarding error handling for the NSCE_ServiceContinuityNegotiation API, HTTP error responses can be supported as specified in clause 5.2.6 of 3GPP TS 29.122. Protocol errors and application errors specified in clause 5.2.6 of 3GPP TS 29.122 can be supported for the HTTP status codes specified in table 5.2.6-1 of 3GPP TS 29.122.

In addition, the requirements in the following clauses can be applicable for the NSCE_ServiceContinuityNegotiation API. The application errors defined for the NSCE_ServiceContinuityNegotiation API are listed in Table 28.

TABLE 28
Application errors

| | | | |
|---|---|---|---|
| Application | HTTP | Description | Applicability |
| Error | status code | | |

Regarding feature negotiations, example optional features are defined for the NSCE_ServiceContinuityNegotiation API can be described in Table 29. Further, optional features can be negotiated using the extensibility mechanism defined in clause 5.2.7 of 3GPP TS 29.122.

TABLE 29
Supported Features

| | | |
|---|---|---|
| Feature number | Feature Name | Description |

Regarding security for the NSCE_ServiceContinuityNegotiation API, the provisions of clause 6 of 3GPP TS 29.122 can apply.

The following presents example YAML code for an example NSCE_ServiceContinuityNegotiation API.

```
openapi: 3.0.0
info:
  title: NSCE_ServiceContinuityNegotiation
  version: 1.0.0-alpha.1
  description: |
  NSCE Server VAL Application Service Continuity Negotiation Service.
  © <2024>, 3GPP Organizational Partners (ARIB, ATIS, CCSA, ETSI, TSDSI,
TTA, TTC).
  All rights reserved.
externalDocs:
  description: >
  3GPP TS 29.435 V0.2.0; Service Enabler Architecture Layer for Verticals
  (SEAL);
  Network Slice Capability Exposure (NSCE) Server Services; Stage 3.
  url: http://www.3gpp.org/ftp/Specs/archive/29_series/29.435/
servers:
  - url: ‘{apiRoot}/nsce-scn/v1’
  variables:
  apiRoot:
  default: https://example.com
  description: apiRoot as defined in clause 6.5 of 3GPP TS 29.549
security:
  - { }
  - oAuth2ClientCredentials: [ ]
paths:
  /SrvContdNeg:
  post:
  summary: Negotiation for service continuity request for a VAL
application.
  operationId: ServiceContinuityNegotiation
  tags:
  - Service Continuity Negotiation
  requestBody:
  required: true
  content:
  application/json:
  schema:
  $ref: ‘#/components/schemas/SrvContdNegReq’
  responses:
  ‘200’:
  description: >
  The negotiation for the service continuity requirement for the VAL
application request
  has been successfully received and processed.
  content:
  application/json:
  schema:
  type: array
  items:
  $ref: ‘#/components/schemas/SrvContdNegRes'
  minItems: 1
  ‘307’:
  $ref: ‘TS29122_CommonData.yaml#/components/responses/307’
  ‘308’:
  $ref: ‘TS29122_CommonData.yaml#/components/responses/308’
  ‘400’:
  $ref: ‘TS29122_CommonData.yaml#/components/responses/400’
  ‘401’:
  $ref: ‘TS29122_CommonData.yaml#/components/responses/401’
  ‘403’:
  $ref: ‘TS29122_CommonData.yaml#/components/responses/403’
  ‘404’:
  $ref: ‘TS29122_CommonData.yaml#/components/responses/404’
  ‘411’:
  $ref: ‘TS29122_CommonData.yaml#/components/responses/411’
  ‘413’:
  $ref: ‘TS29122_CommonData.yaml#/components/responses/413’
  ‘415’:
  $ref: ‘TS29122_CommonData.yaml#/components/responses/415’
  ‘429’:
  $ref: ‘TS29122_CommonData.yaml#/components/responses/429’
  ‘500’:
  $ref: ‘TS29122_CommonData.yaml#/components/responses/500’
  ‘503’:
  $ref: ‘TS29122_CommonData.yaml#/components/responses/503’
  default:
  $ref: ‘TS29122_CommonData.yaml#/components/responses/default’
components:
  securitySchemes:
  oAuth2ClientCredentials:
  type: oauth2
  flows:
  clientCredentials:
  tokenUrl: ‘{tokenUrl}’
  scopes: { }
  schemas:
#
# STRUCTURED DATA TYPES
#
  SrvContdReqt:
  description: >
  Represents negotiation for the service continuity requirement for a VAL
application.
  type: object
  properties:
  valSrvId:
  type: string
  netSliceId:
  $ref:
‘TS29435_NSCE_PolicyManagement.yaml#/components/schemas/NetSliceId’
  contdReqt:
  type: string
  valUeIdsList:
  type: array
  items:
  $ref:
‘TS29549_SS_UserProfileRetrieval.yaml#/components/schemas/ValTargetUe’
  minItems: 1
  appQosReqt:
  type: string
  propTrigAcn:
  $ref: ‘#/components/schemas/TrigAcn’
  required:
  - valSrvId
    netSliceId
    contdReqt
  SrvContdRegt:
  description: >
  Represents negotiation result for the service continuity requirement for
a VAL application.
  type: object
  properties:
  srvContNegRslt:
  type: boolean
  trigAcn:
  $ref: ‘#/components/schemas/TrigAcn’
  required:
  - srvContNegRslt
```

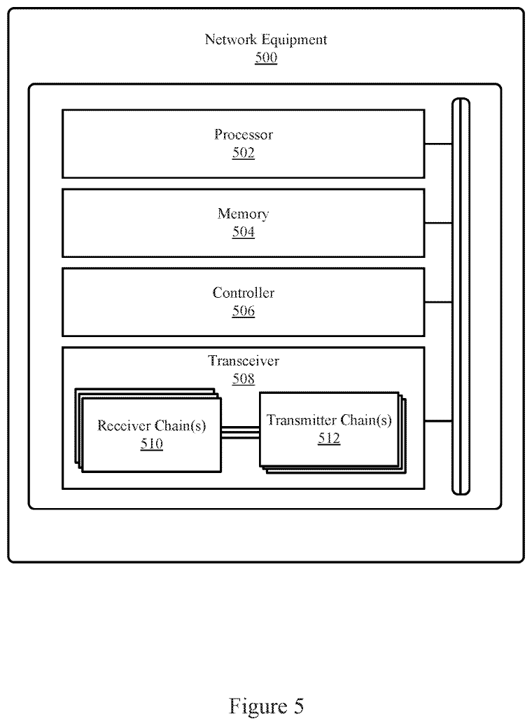

FIG. 5 illustrates an example of a NE 500 in accordance with aspects of the present disclosure. The NE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces. The NE 500 may be implemented in various ways, such as a VAL server, different NSCE servers, different VAL clients, different NSCE clients, etc.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the NE 500 to perform various functions of the present disclosure.

The memory 504 may include volatile or non-volatile memory. The memory 504 may store computer-readable, computer-executable code including instructions when executed by the processor 502 cause the NE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the NE 500 to perform one or more of the functions described herein (e.g., executing, by the processor 502, instructions stored in the memory 504). For example, the processor 502 may support wireless communication at the NE 500 in accordance with examples as disclosed herein.

The NE 500 may be configured to or operable to support a means for transmitting, to a second NE, a first request message for a service operation, the first request message including a first resource URI for a first HTTP POST method and one or more first data types pertaining to a network slice, the service operation including an indication of service continuity for an application; and receiving, from the second NE, a first response message including an updated network slice.

Additionally, the NE 500 may be configured to or operable to support any one or combination of the method further including where the one or more first data types further include an indication of one or more UE associated with the application; the one or more UE include one or more VAL UE; the service operation pertains to service continuity for the one or more VAL UE; the first resource URI includes {apiRoot}/nsce-scr/v1/; the first NE includes a VAL server; the second NE includes a first NSCE server; transmitting the first request message to the second NE based at least in part on an indication of mobility of one or more UE associated with the application.

Additionally, or alternatively, the NE 500 may support at least one memory (e.g., the memory 504) and at least one processor (e.g., the processor 502) coupled with the at least one memory and configured to cause the NE to transmit, to a second NE, a first request message for a service operation, the first request message including a first resource URI for a first HTTP POST method and one or more first data types pertaining to a network slice, the service operation including an indication of service continuity for an application; and receive, from the second NE, a first response message including an updated network slice.

Additionally, the NE 500 may be configured to support any one or combination of where the one or more first data types further include an indication of one or more UE associated with the application; the one or more UE include one or more VAL UE; the service operation pertains to service continuity for the one or more VAL UE; the first resource URI includes {apiRoot}/nsce-scr/v1/; the first NE includes a VAL server; the second NE includes a first NSCE server; the at least one processor is configured to cause the first NE to transmit the first request message to the second NE based at least in part on an indication of mobility of one or more UE associated with the application.

The NE 500 may be configured to or operable to support a means for receiving, from a first NE, a first request message for a service operation, the first request message including a first resource URI for a first HTTP POST method and one or more first data types pertaining to a network slice, the service operation including an indication of service continuity for an application; transmitting, to a third NE, a second request message for the service operation including a second resource URI for a second HTTP POST method and one or more second data types pertaining to a network slice; receiving, from the third NE, a second response message including an updated network slice; and transmitting, to the first NE, a third response message including the updated network slice.

Additionally, the NE 500 may be configured to or operable to support any one or combination of the method further including where the one or more first data types further include an indication of one or more UE associated with the application; the one or more UE include one or more VAL UE; the updated network slice pertains to service continuity for the one or more VAL UE; the first resource URI includes {apiRoot}/nsce-scr/v1/; the first NE includes a VAL server; the second NE includes a first NSCE server; the third NE includes a second NSCE server; the second resource URI includes {apiRoot}/nsce-scn/v1/.

Additionally, or alternatively, the NE 500 may support at least one memory (e.g., the memory 504) and at least one processor (e.g., the processor 502) coupled with the at least one memory and configured to cause the NE to receive, from a first NE, a first request message for a service operation, the first request message including a first resource URI for a first HTTP POST method and one or more first data types pertaining to a network slice, the service operation including an indication of service continuity for an application; transmit, to a third NE, a second request message for the service operation including a second resource URI for a second HTTP POST method and one or more second data types pertaining to a network slice; receive, from the third NE, a second response message including an updated network slice; and transmit, to the first NE, a third response message including the updated network slice.

Additionally, the NE 500 may be configured to support any one or combination of where the one or more first data types further include an indication of one or more UE associated with the application; the one or more UE include one or more VAL UE; the updated network slice pertains to service continuity for the one or more VAL UE; the first resource URI includes {apiRoot}/nsce-scr/v1/; the first NE includes a VAL server; the second NE includes a first NSCE server; the third NE includes a second NSCE server; the second resource URI includes {apiRoot}/nsce-scn/v1/.

The NE 500 may be configured to or operable to support a means for receiving, from a second NE, a second request message for a service operation including a second resource URI for a second HTTP POST method and one or more second data types pertaining to a network slice, the service operation including an indication of service continuity for an application; and transmitting, to the second NE, a second response message including an updated network slice.

Additionally, the NE 500 may be configured to or operable to support any one or combination of where the one or more second data types further include an indication of one or more UE associated with the application; the one or more UE include one or more VAL UE; the updated network slice pertains to service continuity for the one or more VAL UE; the second resource URI includes {apiRoot}/nsce-scn/v1/; the second NE includes a first NSCE server and the third NE includes a second NSCE server.

Additionally, or alternatively, the NE 500 may support at least one memory (e.g., the memory 504) and at least one processor (e.g., the processor 502) coupled with the at least one memory and configured to cause the NE to receive, from a second NE, a second request message for a service operation including a second resource URI for a second HTTP POST method and one or more second data types pertaining to a network slice, the service operation including an indication of service continuity for an application; and transmit, to the second NE, a second response message including an updated network slice.

Additionally, the NE 500 may be configured to support any one or combination of where the one or more second data types further include an indication of one or more UE associated with the application; the one or more UE include one or more VAL UE; the updated network slice pertains to service continuity for the one or more VAL UE; the second resource URI includes {apiRoot}/nsce-scn/v1/; the second NE includes a first NSCE server and the third NE includes a second NSCE server.

The controller 506 may manage input and output signals for the NE 500. The controller 506 may also manage peripherals not integrated into the NE 500. In some implementations, the controller 506 may utilize an operating system such as iOS®, ANDROID®, WINDOWS®, or other operating systems. In some implementations, the controller 506 may be implemented as part of the processor 502.

In some implementations, the NE 500 may include at least one transceiver 508. In some other implementations, the NE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

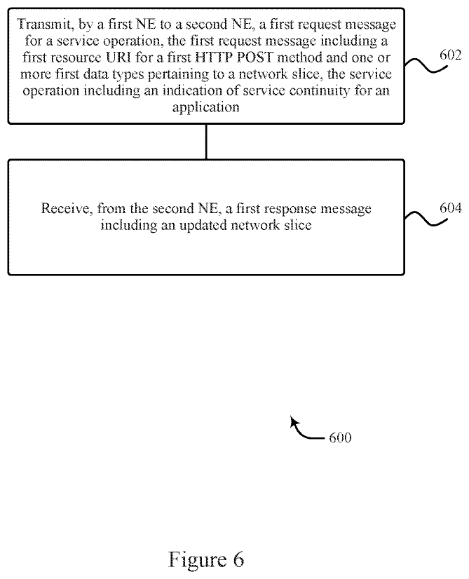

FIG. 6 illustrates a flowchart of a method 600 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 602, the method may include transmitting, by a first NE to a second NE, a first request message for a service operation, the first request message including a first resource URI for a first HTTP POST method and one or more first data types pertaining to a network slice, the service operation including an indication of service continuity for an application. The operations of 602 may be performed in accordance with examples as described herein. In some implementations, aspects of the operations of 602 may be performed by a NE as described with reference to FIG. 4.

At 604, the method may include receiving, from the second NE, a first response message including an updated network slice. The operations of 604 may be performed in accordance with examples as described herein. In some implementations, aspects of the operations of 604 may be performed by a NE as described with reference to FIG. 4.

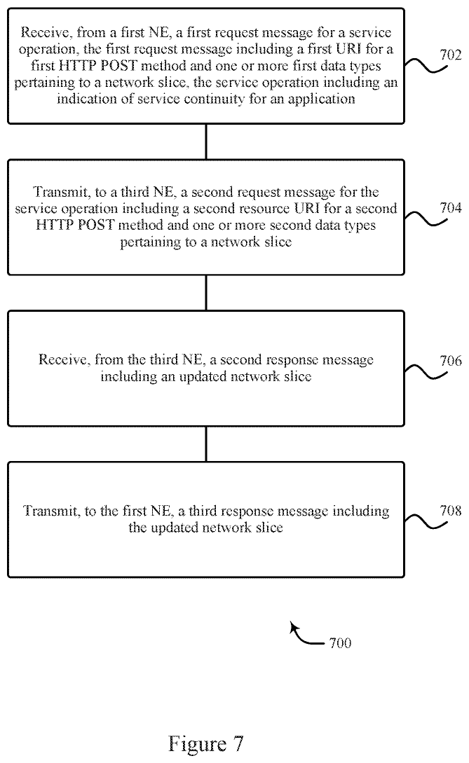

FIG. 7 illustrates a flowchart of a method 700 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 702, the method may include receiving, from a first NE, a first request message for a service operation, the first request message including a first URI for a first HTTP POST method and one or more first data types pertaining to a network slice, the service operation including an indication of service continuity for an application. The operations of 702 may be performed in accordance with examples as described herein. In some implementations, aspects of the operations of 702 may be performed by a NE as described with reference to FIG. 4.

At 704, the method may include transmitting, to a third NE, a second request message for the service operation including a second resource URI for a second HTTP POST method and one or more second data types pertaining to a network slice. The operations of 704 may be performed in accordance with examples as described herein. In some implementations, aspects of the operations of 704 may be performed by a NE as described with reference to FIG. 4.

At 706, the method may include receiving, from the third NE, a second response message including an updated network slice. The operations of 706 may be performed in accordance with examples as described herein. In some implementations, aspects of the operations of 706 may be performed a NE as described with reference to FIG. 4.

At 708, the method may include transmitting, to the first NE, a third response message including the updated network slice. The operations of 708 may be performed in accordance with examples as described herein. In some implementations, aspects of the operations of 708 may be performed a NE as described with reference to FIG. 4.

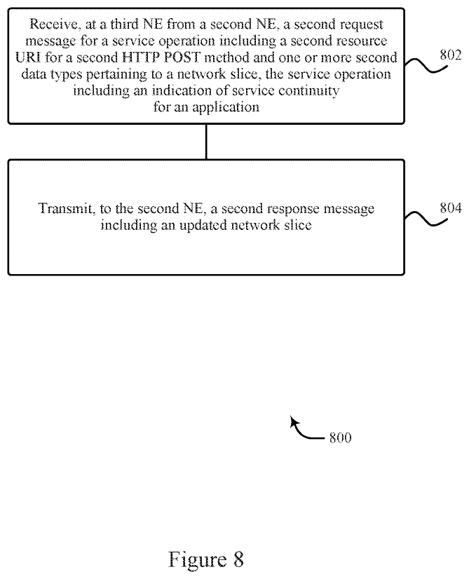

FIG. 8 illustrates a flowchart of a method 800 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 802, the method may include receiving, at a third NE from a second NE, a second request message for a service operation including a second resource URI for a second HTTP POST method and one or more second data types pertaining to a network slice, the service operation including an indication of service continuity for an application. The operations of 802 may be performed in accordance with examples as described herein. In some implementations, aspects of the operations of 802 may be performed by a NE as described with reference to FIG. 4.

At 804, the method may include transmitting, to the second NE, a second response message including an updated network slice. The operations of 804 may be performed in accordance with examples as described herein. In some implementations, aspects of the operations of 804 may be performed by a NE as described with reference to FIG. 4.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network equipment (NE) for wireless communication, comprising:
at least one memory; and
at least one processor coupled with the at least one memory and operable to cause the first NE to:
transmit, to a second NE, a first request message for a service operation, the first request message comprising a first resource Uniform Resource Identifier (URI) for a first Hypertext Transfer Protocol (HTTP) POST method and one or more first data types pertaining to a network slice, the service operation comprising an indication of service continuity for an application; and
receive, from the second NE, a first response message comprising an updated network slice.

2. The first NE of claim 1, wherein the one or more first data types further comprise an indication of one or more user equipment (UE) associated with the application.

3. The first NE of claim 2, wherein the one or more UE comprise one or more Vertical Application Layer (VAL) UE.

4. The first NE of claim 1, wherein the service operation pertains to service continuity for the one or more VAL UE.

5. The first NE of claim 1, wherein the first resource URI comprises {apiRoot}/nsce-scr/v1/.

6. The first NE of claim 1, wherein the first NE comprises a Vertical Application Layer (VAL) server.

7. The first NE of claim 1, wherein the second NE comprises a first Network Slice Capability Exposure (NSCE) server.

8. The first NE of claim 1, wherein the at least one processor is operable to cause the first NE to transmit the first request message to the second NE based at least in part on an indication of mobility of one or more user equipment (UE) associated with the application.

9. A second network equipment (NE) for wireless communication, comprising:
at least one memory; and
at least one processor coupled with the at least one memory and operable to cause the second NE to:
receive, from a first NE, a first request message for a service operation, the first request message comprising a first resource Uniform Resource Identifier (URI) for a first Hypertext Transfer Protocol (HTTP) POST method and one or more first data types pertaining to a network slice, the service operation comprising an indication of service continuity for an application;
transmit, to a third NE, a second request message for the service operation comprising a second resource URI for a second HTTP POST method and one or more second data types pertaining to a network slice;
receive, from the third NE, a second response message comprising an updated network slice; and
transmit, to the first NE, a third response message comprising the updated network slice.

10. The second NE of claim 9, wherein the one or more first data types further comprise an indication of one or more user equipment (UE) associated with the application.

11. The second NE of claim 10, wherein the one or more UE comprise one or more Vertical Application Layer (VAL) UE.

12. The second NE of claim 11, wherein the updated network slice pertains to service continuity for the one or more VAL UE.

13. The second NE of claim 9, wherein the first resource URI comprises {apiRoot}/nsce-scr/v1/.

14. The second NE of claim 9, wherein the first NE comprises a Vertical Application Layer (VAL) server.

15. The second NE of claim 9, wherein the second NE comprises a first Network Slice Capability Exposure (NSCE) server.

16. The second NE of claim 15, wherein the third NE comprises a second NSCE server.

17. The second NE of claim 9, wherein the second resource URI comprises {apiRoot}/nsce-scn/v1/.

18. A third network equipment (NE) for wireless communication, comprising:
at least one memory; and
at least one processor coupled with the at least one memory and operable to cause the third NE to:
receive, from a second NE, a second request message for a service operation comprising a second resource Uniform Resource Identifier (URI) for a second Hypertext Transfer Protocol (HTTP) POST method and one or more second data types pertaining to a network slice, the service operation comprising an indication of service continuity for an application; and
transmit, to the second NE, a second response message comprising an updated network slice.

19. A method performed by a first network equipment (NE), the method comprising:
transmitting, to a second NE, a first request message for a service operation, the first request message comprising a first resource Uniform Resource Identifier (URI) for a first Hypertext Transfer Protocol (HTTP) POST method and one or more first data types pertaining to a network slice, the service operation comprising an indication of service continuity for an application; and
receiving, from the second NE, a first response message comprising an updated network slice.

20. The method of claim 19, wherein the first NE comprises a Vertical Application Layer (VAL) server, and the second NE comprises a first Network Slice Capability Exposure (NSCE) server.
